(19) United States
(12) Patent Application Publication
(10) Pub. No.: US 2005/0246333 A1
(43) Pub. Date: Nov. 3, 2005

(54) Method and apparatus for classifying documents

(76) Inventors: Jiang-Liang Hou, Hsinchu City (TW); Fong-Hsin Lin, Baunchio City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/835,685

(22) Filed: Apr. 30, 2004

(51) Int. Cl. G06F 7/00

(52) U.S. Cl. 707/5

(57) ABSTRACT

A method of classifying documents is characterized by a process of assigning a title to an object document. The method is also characterized by a process of obtaining data representing the relationship between keywords and document titles. The former process features a mathematical operation between the data and the frequencies of keywords appearing in the object document, to obtain a group of reference numbers representing the relationship between the object document and the document titles, thereby at least one of the document titles is assigned to the object document according to the reference numbers. The latter process features mathematical operations on the frequencies of keywords appearing in the documents to which the document titles having been assigned, such as the documents in a historical record.

### FIELD OF THE INVENTION

The present invention generally relates to document classification, and particularly to schemes of assigning, according to a specific database, at least one document-category title to an object document.

### BACKGROUND OF THE INVENTION

Analysis, induction, merging or integration, sharing, and communication, as well as access authorization of information (including knowledge, messages, and data) have been playing very significant roles for years as many people have long been besieged with an astronomical amount of information. This is particularly obvious now that diversity or variety is dominating almost every thing and activity in the world, and information flow among people, organizations, and nations turns out so huge. Information management, no matter in terms of analysis, or induction, or merging/integration, or sharing, or communication, or access authorization, relies on classification of various documents (including knowledge, message, data, and another type of information). Although a variety of methods/systems for managing electronic files have been developed to raise the efficiency and reliability of transmitting and sharing messages/data/information/documents, one providing ideal schemes for classifying documents is still expected.

Although document classification may be done by charging a group of administration staff with responsibility of classifying all documents, too much reliance on human being's knowledge, experience, caution, stable mood, and constant or consistent criteria for making judgments constitutes critical problem. This is particularly true considering the difficulty of having the same staff to work all the time. Even if it is possible to keep the same group of people work all the time, difference of judgment among different ones of the group can still be a problem, not to mention that the same person may have different judgments at different times. Furthermore, the huge amount of information faced by people or organizations now, if classified solely on the basis of human being's judgment, is certainly to consume huge manpower, resulting in high cost in addition to mistakes originating from human being's subjective views. The problem will be more serious in the future as the amount of information not only is increasing, but also is being diversified.

Improper classification of documents inevitably results in heavy time-consuming, poor efficiency, or uncontrollable/inconsistent/disorderly procedures in managing information. Specifically improper classification itself makes any related database and communication in a state of chaos, and unreliable access authorization originating therefrom further brings about redundant communication which, not only occupy the capacity of communication channel, but also add extra work load to people or organizations who are supposed to strain off irrelevant messages/data/information/documents from the bulky material received all the time.

Although U.S. Pat. Nos. 6,243,723 and 5,832,470 might be deemed in relation to the fields similar to the present invention, they are substantially different from the present invention in terms of either algorithm or achievements. No any prior art has ever been known to substantially address the aforementioned issues of classifying documents. This is why a method/apparatus providing ideal classification of documents (or messages/data/information/knowledge) on the basis of automation or computer processing is broadly expected now and will even be more in the future.

### SUMMARY OF THE INVENTION

Definition

The expression “document” or “documents” in the disclosure means “message” or “messages” or “data” or “knowledge” or any information which can be stored and is readable.

The expression “word” or “words” or “word code” or “word codes” in the disclosure means “one or more than one symbol which can be stored in a machine and is readable by a machine and/or human being”. For example, English expression “a” or “people” or “security” or punctuation mark “;”, etc is a word or word code according to the disclosure. Obviously any word in another language is also a word or word code according to the disclosure.

Objects

An object of the present invention is to provide a method/apparatus in managing documents, for an organization or agency or people to promote its capability of adapting to knowledge based economy.

Another object of the present invention is to overcome the bottle-neck of achieving what is expected of processing documents electronically or systematically.

A further object of the present invention is to provide a method/apparatus in managing documents, by which network communication can be better exploited by various organizations and enterprises to process their internal documents.

Another further object of the present invention is to provide a method/apparatus in managing documents, by which the information communication between different people, organizations, and enterprises can be more smooth and efficient.

Still another further object of the present invention is to provide a method/apparatus in managing documents, by which various people, organizations, and enterprises can manage documents in a way with less time consumption, lower cost, and minimum complication.

Operating Algorithm

The present invention features a process for assigning, according to a database, at least one of a plurality of document-category titles to an object document, wherein the object document includes one or more than one key word, and the database includes a plurality of keyword-to-document-category-relevance-referring numbers respectively correspond to the key words, and to the document-category titles. One of the keyword-to-document-category-relevance-referring numbers which corresponds to an arbitrarily selected one of the key words, and to an arbitrarily selected one of the document-category titles, represents or relates to the probability the arbitrarily selected key word appears in a document with the arbitrarily selected document-category title, i.e., represents or relates to the probability the arbitrarily selected key word appears in a document classified into the arbitrarily selected document-category.

The present invention also features a process for obtaining, according to a record file, the plurality of keyword-to-document-category-relevance-referring numbers, the record file including a plurality of record documents each corresponding to at least one of the document-category titles.

The present invention further features an apparatus for storing the plurality of keyword-to-document-category-relevance-referring numbers and/or another information/data.

Furthermore the present invention features an apparatus for performing the aforementioned processes.

The present invention may best be understood through the following description with reference to the accompanying drawings, in which:

### BRIEF DESCRIPTION OF THE DRAWINGS

FIG. 1 is a flow chart showing a scheme for embodying a document-category-assigning process according to the present invention.

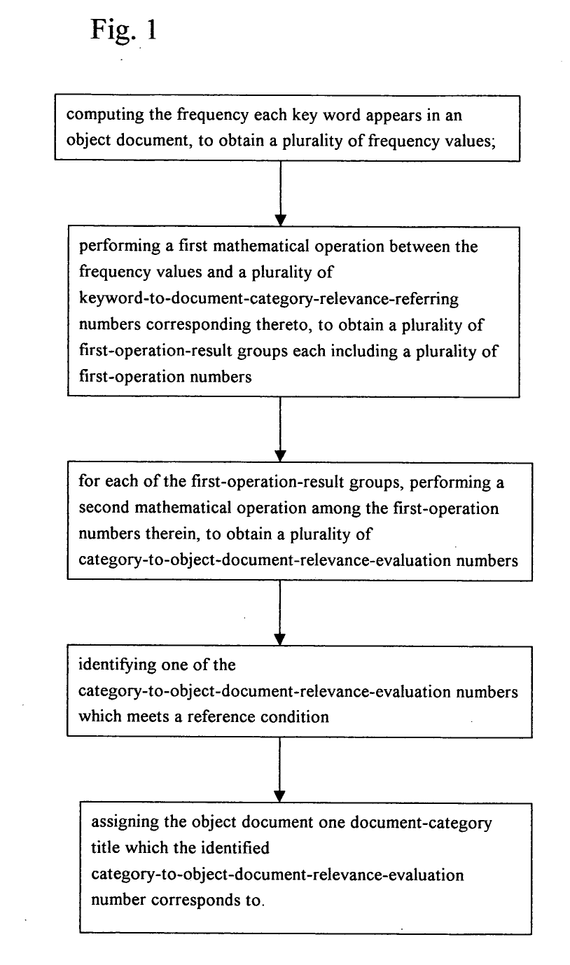

FIG. 2 shows a schematic view of an embodiment example of apparatus configured according to the present invention.

### DETAILED DESCRIPTION OF THE INVENTION

A method provided by the present invention for classifying documents, comprises a document-category-assigning process for assigning, according to a plurality of reference-number groups, at least one of a plurality of document-category titles to an object document, wherein the object document includes a plurality (at least two, for example) of key words (denoted by KW(1), . . . , KW(j), . . . , KW(m) in this disclosure), the reference-number groups [denoted by R(1), . . . , R(q), . . . , R(u) in this disclosure] correspond to the document-category titles g(1), . . . , g(q), . . . , g(u) in a way of one-to-one, i.e., each of the reference-number groups corresponds to a different one of the plurality of document-type titles, each of the reference-number groups R(1), . . . , R(q), . . . , R(u) includes a plurality of keyword-to-document-category-relevance-referring numbers corresponding to the key words KW(1), . . . , KW(j), . . . , KW(m) in a way of one-to-one, i.e., each of the keyword-to-document-category-relevance-referring numbers included in each [R(q), for example] of the reference-number groups R(1), . . . , R(q), . . . , R(u) corresponds to a different one of the key words KW(1), . . . , KW(j), . . . , KW(m). One of the keyword-to-document-category-relevance-referring numbers which corresponds to an arbitrarily selected key word [KW(j), for example], and is included in one reference-number group [R(q), for example] that corresponds to an arbitrarily selected document-category title [g(q), for example], represents or relates to the probability the arbitrarily selected key word KW(j) appears in a document with the arbitrarily selected document-category title g(q), i.e., represents or relates to the probability the arbitrarily selected key word KW(j) appears in a document which has the arbitrarily selected document-category title g(q) assigned thereto. For easier understanding of the method provided by the present invention for classifying documents, an example of obtaining these keyword-to-document-category-relevance-referring numbers [or the reference-number groups R(1), . . . , R(q), . . . , R(u)], i.e., a reference-number-calculation process is described as follows. The reference-number-calculation process obtains the reference-number groups (or the keyword-to-document-category-relevance-referring numbers), according to a record file including a plurality of record documents each corresponding to at least one of the document-category titles, i.e., each of the record documents has been or had been assigned one or more than one of the document-category titles g(1), . . . , g(q), . . . , g(u). Alternatively speaking, each of the record documents has been or had been classified in one or more than one document-category. The plurality of record documents are denoted by D1, . . . , Dn, . . . , Dy hereinafter. A scheme for embodying the reference-number-calculation process comprises the steps of:
(a) identifying a same-category group of record documents D1, D2, . . . , Dn among the plurality of record documents D1, . . . , Dn, . . . , Dy in such a way that the same-category group of record documents D1, D2, . . . , Dn correspond to an arbitrarily selected document-category title g(q) among the plurality of document-category titles g(1), . . . , g(q), . . . , g(u);
(b) counting the number of the record documents D1, D2, . . . , Dn in the same-category group of record documents, to obtain a document-of same-category number N;
(c) computing the frequencies an arbitrarily selected key word (KW(j), for example) appears in the same-category group of record documents D1, D2, . . . , Dn, to obtain a plurality of frequency values Fj1, Fj2, . . . , Fjn respectively representing the frequencies the arbitrarily selected key word KW(j) appears in the same-category group of record documents D1, D2, . . . , Dn; and
(d) summing the frequency values Fj1, Fj2, . . . , Fjn to obtain a summed frequency number SFj (=Fj1+Fj2+ . . . +Fjn), and dividing the summed frequency number SFj by the document-of same-category number N to obtain an average-frequency AFj (=SFj÷N) that is one [denoted by KTRB(j,q) in this disclosure] of the keyword-to-document-category-relevance-referring numbers which corresponds to the arbitrarily selected key word KW(j) and to the arbitrarily selected document-category title g(q).

Repeating the steps of (c) and (d) above for different key words, i.e., key words KW(1), . . . , KWj−1), KW(j+1), . . . , KW(m) in addition to KW(j), a group of keyword-to-document-category-relevance-referring numbers [denoted by KTRB(1,k), KTRB(2,k), . . . , KTRB(m,k) in this disclosure] which respectively correspond to the key words KW(1), KW(2), . . . , KW(m) and all correspond to the document-category title g(q) are obtained.

Repeating the steps of (a), (b), (c), and (d) above for different document-category titles g(1), . . . , g(q−1), g(q+1), . . . , g(u) in addition to g(q), and for all key words KW(1), . . . , KW(m), a plurality of reference-number groups are obtained, wherein the reference-number groups correspond to the document-category titles g(1), . . . , g(u) in a way of one-to-one, and each of the reference-number groups includes a plurality of keyword-to-document-category-relevance-referring numbers corresponding to the key words KW(1), . . . , KW(m) in a way of one-to-one, thereby all the keyword-to-document-category-relevance-referring numbers included in one of the reference-number groups which corresponds to a document-category title [g(u), for example], shall correspond to the document-category title g(u).

An arbitrarily selected one [KTRB(i,j), for example] of the keyword-to-document-category-relevance-referring numbers represents or relates to the probability a key word KW(i) appears in a document with document-category title g(j), i.e., represents or relates to the probability a key word KW(i) appears in a document classified into a document category entitled g(j).

The aforementioned scheme for embodying the reference-number-calculation process according to the present invention may be such that a frequency value (Fjn, for example) representing the frequency the arbitrarily selected key word KW(j) appears in record document Dn, is the result of dividing the times (denoted by JNT in this disclosure) the key word KW(j) appears in record document Dn by the number of total words (denoted by NWDn in this disclosure) in record document Dn, i.e., Fjn=JNT÷NWDn, or the frequency value is obtained in another way, as can be seen from another scheme for embodying the reference-number-calculation process, which comprises:
(e) identifying a same-category group of record documents D1, D2, . . . , Dn among the plurality of record documents D1, . . . , Dn, . . . , Dy in such a way that the same-category group of record documents D1, D2, . . . , Dn correspond to an arbitrarily selected document-category title g(q) among the plurality of document-category titles g(1), . . . , g(q), . . . , g(u);
(f) counting the number of the record documents D1, D2, . . . , Dn in the same-category group of record documents, to obtain a document-of same-category number N;
(g) computing the times each of the key words KW(1), . . . , KW(m) appears in an arbitrarily selected one (D2, for example) of the record documents D1, D2, . . . , Dn in the same-category group, to obtain a plurality of times-numbers [denoted by TND2(1), TND2(2), . . . , TND2(m) in this disclosure] respectively representing the times the key words KW(1), . . . , KW(m) appear in the arbitrarily selected record document D2 (which is in the same-category group);
(h) summing the times-numbers TND2(1), TND2(2), . . . , TND2(m) to obtain a summed times-number STND2, and dividing an arbitrarily selected one [TND2(m), for example] of the times-numbers by the summed times-number STND2 to obtain a frequency value FmD2 [=TND2(m)÷STND2] representing the frequency a corresponding key word KW(m) appears in the arbitrarily selected record document D2 (which is in the same-category group), wherein the corresponding key word KW(m) is the one of the key words which corresponds to the arbitrarily selected the times-number TND2(m), i.e., the corresponding key word KW(m) is the one of the key words which has appeared in document D2 for times represented by the times-number TND2(m);
(i) repeating the steps of (g) and (h) for different record documents in the same-category group, i.e., record documents D1, D3, . . . , Dn in addition to D2, until a plurality of frequency values FmD1, FmD2, . . . , FmDn are obtained wherein the frequency values FmD1, FmD2, . . . , FmDn respectively represent the frequencies the corresponding key word KW(m) appears in different record documents D1, D3, . . . , Dn in addition to D2 (D1, D2, D3, . . . , Dn all in the same-category group);
(j) summing the frequency values FmD1, FmD2, . . . , FmDn to obtain a summed frequency number SFm, and dividing the summed frequency number SFm by the document-of same-category number N, to obtain an average-frequency Afm (=SFm÷N) that is one [denoted by KTRB(m,k) in this disclosure] of the keyword-to-document-category-relevance-referring numbers which corresponds to the arbitrarily selected key word KW(m) and to the arbitrarily selected document-category title g(q).

Repeating the steps of (e), (f), (g), (i), and (j) above for different document-category titles g(1), . . . , g(q−1), g(q+1), . . . , g(u) in addition to g(q), and for all key words KW(1), . . . , KW(m), a plurality of reference-number groups are obtained, wherein the reference-number groups correspond to the document-category titles g(1), . . . , g(q) . . . , g(u) in a way of one-to-one, and each of the reference-number groups includes a plurality of keyword-to-document-category-relevance-referring numbers corresponding to the key words KW(1), . . . , KW(m) in a way of one-to-one, thereby all the keyword-to-document-category-relevance-referring numbers included in one of the reference-number groups which corresponds to a document-category title [g(u), for example], shall correspond to the document-category title g(u). For example, for one of the reference-number groups which corresponds to a document-category title g(u), the keyword-to-document-category-relevance-referring numbers KTRB(1,n), KTRB(2,n), . . . , KTRB(m,n) therein all correspond to document-category title g(u), and respectively correspond to the key words KW(1), . . . , KW(m) in a way of one-to-one. An arbitrarily selected one [KTRB(i,j), for example] of the keyword-to-document-category-relevance-referring numbers represents or relates to the probability a key word KW(i) appears in a document with document-category title g(j).

The reference-number-calculation process according to the present invention, may also be configured to comprise the steps of:
(k) identifying a same-category group of record documents D1, D2, . . . , Dn among the plurality of record documents D1, . . . , Dn, . . . , Dy in such a way that the same-category group of record documents D1, D2, . . . , Dn correspond to an arbitrarily selected document-category title g(q) among the plurality of document-category titles g(1), . . . , g(q), . . . , g(u);
(l) counting the number of words in the same-category group of record documents, i.e., counting the number of all the words appearing in record documents D1, D2, . . . , Dn included in the same-category group [and thereby correspond to the arbitrarily selected document-category title g(q)], to obtain a document-of same-category-word-total number (denoted by NWK in this disclosure);
(m) computing the times an arbitrarily selected one [KW(j), for example] of the key words appears in the same-category group of record documents D1, D2, . . . , Dn, to obtain a times-number [denoted by TN(j,q) in this disclosure] corresponding to the arbitrarily selected key word KW(j) and to the arbitrarily selected document-category title g(q), and dividing the times-number TN(j,q) by the document-of same-category-word-total number NWK, to obtain one [denoted by KTRB(j,q) which is TN(j,q)÷NWK] of the keyword-to-document-category-relevance-referring numbers which corresponds to the arbitrarily selected key word KW(j), and to the arbitrarily selected document-category title g(q).

Repeating the steps of (k), (l), and (m) above for different document-category titles g(1), . . . , g(q−1), g(q+1), . . . , g(u) in addition to g(q), and for all key words KW(1), . . . , KW(m), a plurality of reference-number groups are obtained, wherein the reference-number groups correspond to the document-category titles g(1), . . . , g(u) in a way of one-to-one, and each of the reference-number groups includes a plurality of keyword-to-document-category-relevance-referring numbers corresponding to the key words KW(1), . . . , KW(m) in a way of one-to-one, thereby all the keyword-to-document-category-relevance-referring numbers included in one of the reference-number groups which corresponds to a document-category title [g(u), for example], shall correspond to the document-category title g(u).

All the keyword-to-document-category-relevance-referring numbers and/or the reference-number groups usually constitute or are included in a database residing on a data storage portion of a device (particularly an information management system, specifically a computer). Obviously a plurality of key words corresponded by these keyword-to-document-category-relevance-referring numbers, and the document-category titles g(1), . . . , g(u) corresponded by the reference-number groups, may also constitute or be included in a database residing on a data storage portion of the device.

The aforementioned method provided by the present invention may further comprise a reference-number-adjusting process for adjusting the keyword-to-document-category-relevance-referring numbers, to adapt the method to the condition that any record document unusually contains too many or too few of a key word, i.e., one (or more than one) key word appears in a record document too many or too few times compared to the average of the times the key word appears in all the record documents with the same document-category title (i.e., in the same document-category). A scheme for embodying the reference-number-adjusting process with reference to the step (d) above, comprises:
in case one of the frequency values Fj1, Fj2, . . . , Fjn differs from the average-frequency AFj by a difference-amount larger an adjust-criteria value ACV, i.e., if Fjm (for example) of the frequency values Fj1, Fj2, . . . , Fjn is such that |Fjm−Afj|>ACV, adjusting the frequency value Fjm to be a value differing from the average-frequency AFj by the adjust-criteria value ACV. In other words, if (Fjm−AFj)>ACV, replacing Fjm by (AFj+ACV); while if (AFj−Fjm)>ACV, replacing Fjm by (AFj−ACV).

A scheme for embodying the reference-number-adjusting process with reference to the step (j) above is on the analogy of the one above, and needs no description.

Another scheme for embodying the reference-number-adjusting process with reference to the step (d) above, comprises:
in case one of the frequency values Fj1, Fj2, . . . , Fjn exceeds the average-frequency AFj by a difference larger than a first adjust-criteria value FACV, i.e., if Fjm (for example) of the frequency values Fj1, Fj2, . . . , Fjn is such that (Fjm−AFj)>FACV, reducing the frequency value Fjm by a first-adjusting amount FAA, i.e., replacing Fjm by (Fjm−FAA); and
in case one (Fji, for example) of the frequency values Fj1, Fj2, . . . , Fjn is lesser than the average-frequency AFj by a difference larger than a second adjust-criteria value SACV, i.e., if Fji is such that (AFj−Fji)>SACV, increasing the frequency value Fji by a second-adjusting amount SAA, i.e., replacing Fji by (Fji+SAA).

Obviously the frequency values such as Fj1, Fj2, . . . , Fjn or the like, the adjust-criteria value ACV, the first adjust-criteria value FACV, the first-adjusting amount FAA, the second adjust-criteria value SACV, and the second-adjusting amount SAA, may also constitute or be included in a database residing on a data storage portion of a device (particularly an information management system, specifically a computer).

Based on the keyword-to-document-category-relevance-referring numbers each [KTRB(i,j), for example] representing or relating to the probability a key word KW(i) appears in a document with document-category title g(j), the the present invention provides a document-category-assigning process for assigning, according to a plurality of reference-number groups, at least one of a plurality of document-category titles g(1), . . . , g(u) to an object document (denoted by Dt in this disclosure), wherein the object document Dt includes at least two key words KW(1), . . . , KW(m), the reference-number groups correspond to document-category titles g(1), . . . , g(u) in a way of one-to-one, each of the reference-number groups includes a plurality of keyword-to-document-category-relevance-referring numbers corresponding to the key words KW( ), . . . , KW(m) in a way of one-to-one. One scheme for embodying the document-category-assigning process comprises:
computing the frequency each of the key words KW(1), . . . , KW(m) appears in the object document Dt, to obtain a plurality of frequency values F1t, F2t, . . . , Fmt corresponding to the key words KW(1), . . . , KW(m) in a way of one-to-one, and thereby being corresponded, in a way of one-to-one, by the keyword-to-document-category-relevance-referring numbers which are included in each of the reference-number groups, i.e., frequency values F1t, F2t, . . . , Fmt are corresponded, in a way of one-to-one, by the keyword-to-document-category-relevance-referring numbers KTRB(i,j), KTRB(2,j), KTRB(3,j), . . . , KTRB(m,j) included in a reference-number group R(j) for each j where j=1, 2, . . . , q, . . . , u, in other words, the keyword-to-document-category-relevance-referring numbers included in any one of the reference-number groups correspond to the frequency values F1t, F2t, . . . , Fmt in a way of one-to-one;
performing a first mathematical operation (denoted by \mathring{×} in this disclosure) between each of the frequency values F1t, F2t, . . . , Fmt and each of the keyword-to-document-category-relevance-referring numbers which corresponds thereto (please note that each of the reference-number groups includes a plurality of keyword-to-document-category-relevance-referring numbers corresponding to frequency values F1t, F2t, . . . , Fmt in a way of one-to-one), to obtain a plurality of first-operation-result groups (denoted by FR(1), . . . , FR(u) in this disclosure) each including a plurality of first-operation numbers, i.e., one [FR(p), for example] of the first-operation-result groups FR(1), . . . , FR(u) includes FON(1,p)=F1t\mathring{×}KTRB(1,p), FON(2,p)=F2t\mathring{×}KTRB(2,p), . . . , FON(m,p)=Fmt\mathring{×}KTRB(m,p) where p=1, . . . , u, and FON(1,p), . . . , FON(m,p) result from the first mathematical operation \mathring{×}, and respectively correspond to different keyword-to-document-category-relevance-referring numbers KTRB(1,p), . . . , KTRB(m,p) included in one [denoted by R(p)] of the reference-number groups R(1), . . . , R(q), . . . , R(u), thereby the first-operation-result groups FR(1), . . . , FR(u) correspond to the reference-number groups R(1), . . . , R(q), . . . , R(u) in a way of one-to-one, whereby first-operation-result groups FR(1), . . . , FR(u) correspond to document-category titles g(1), . . . , g(q), . . . , g(u) in a way of one-to-one, because the reference-number groups R(1), . . . , R(q), . . . , R(u) correspond to document-category titles g(1), . . . , g(q), . . . , g(u) in a way of one-to-one;
for each of the first-operation-result groups FR(1), . . . , FR(q), . . . , FR(u), performing a second mathematical operation (denoted by ⊕ in this disclosure) among the first-operation numbers therein, to obtain a plurality of category-to-object-document-relevance-evaluation numbers respectively corresponding to different ones of the document-category titles, i.e., for one [R(p), for example] of the first-operation-result groups FR(1), . . . , FR(u), performing the second mathematical operation ⊕ among the first-operation numbers FON(1,p), FON(2,p), . . . , FON(m,p) therein where p=1, . . . , u, and FON(1,p)=F1t\mathring{×}KTRB(1,p), FON(2,p)=F2t\mathring{×}KTRB(2,p), . . . , FON(m,p)=Fmt\mathring{×}KTRB(m,p) where p=1, . . . , u, to obtain a plurality of category-to-object-document-relevance-evaluation numbers DREN(1), . . . , DREN(q), . . . , DREN(u), where DREN(1)=FON(1,1)⊕FON(2,1)⊕FON(3,1)⊕ . . . ⊕FON(m,1), DREN(q)=FON(1,q)⊕FON(2,q)⊕FON(3,q)⊕ . . . ⊕FON(m,q), DREN(u)=FON(1,u)⊕FON(2,u)⊕FON(3,u)⊕ . . . ⊕FON(m,u), and category-to-object-document-relevance-evaluation numbers DREN(1), . . . , DREN(q), . . . , DREN(u) correspond to document-category titles g(1), . . . , g(q), . . . , g(u) in a way of one-to-one, because the first-operation-result groups FR(1), . . . , FR(q), . . . , FR(u) correspond to document-category titles g(1), . . . , g(q), . . . , g(u) in a way of one-to-one;
identifying one [DREN(q), for example] of the category-to-object-document-relevance-evaluation numbers DREN(1), . . . , DREN(q), . . . , DREN(u) which meets a reference condition (magnitude larger than a specified value, for example); and
assigning the object document one document-category title g(q) which the identified category-to-object-document-relevance-evaluation number DREN(q) corresponds to, and the object document is thus classified into a document-category entitled g(q).

In the document-category-assigning process above, if more than one [DREN(p) in addition to DREN(q), for example] of the category-to-object-document-relevance-evaluation numbers DREN(1), . . . , DREN(q), . . . , DREN(u) is identified meeting the reference condition, the object document is classified into more than one document-category, i.e., in document-categories entitled g(p) and g(q).

To be easier understood, DREN(1)=FON(1,1)⊕FON(2,1)⊕ . . . ⊕FON(m,1)=F1t\mathring{×}KTRB(1,1)⊕(F2t\mathring{×}KTRB(2,1)⊕ . . . ⊕Fmt\mathring{×}KTRB(m,1); DREN(q)=FON(1,q)⊕FON(2,q)⊕ . . . ⊕FON(m,q)=F1t\mathring{×}KTRB(1,q)⊕F2t\mathring{×}KTRB(2,q)⊕ . . . ⊕Fmt\mathring{×}KTRB(m,q); DREN(u)=FON(1,u)⊕(FON(2,u)⊕ . . . ⊕FON(m,u)=F1t\mathring{×}KTRB(1,u)⊕F2t\mathring{×}KTRB(2,u)⊕ . . . ⊕Fmt\mathring{×}KTRB(m,u). In other words, for each q where q=1, 2, . . . , u, a first-operation-result group FR(q) includes FON(1,q)=F1t\mathring{×}KTRB(1,q), FON(2,q)=F2t\mathring{×}KTRB(2,q), . . . , FON(m,q)=Fmt\mathring{×}KTRB(m,q), performing the second mathematical operation ⊕ among the first-operation numbers FON(1,q), FON(2,q), . . . , FON(m,q) in the first-operation-result group FR(q), a category-to-object-document-relevance-evaluation number DREN(q)=FON(1,q) ⊕FON(2,q)⊕ . . . ⊕FON(m,q)=F1t\mathring{×}KTRB(1,q)⊕F2t\mathring{×}KTRB(2,q)⊕ . . . ⊕Fmt\mathring{×}KTRB(m,q) is obtained corresponding to a document-category entitled g(q) where u≧q≧1.

In the document-category-assigning process above, the first mathematical operation \mathring{×}may be multiplication usually denoted by ×, and the second mathematical operation ⊕ may be addition usually denoted by +.

In the document-category-assigning process above, the reference condition may be “larger than a category-judge-criteria-value”, i.e., the reference condition is such that one [DREN(q), for example] of the category-to-object-document-relevance-evaluation numbers is identified if the magnitude thereof [the magnitude of DREN(q)] is larger than the category-judge-criteria-value. Alternatively the reference condition may be such that one [DREN(p), for example] of the category-to-object-document-relevance-evaluation numbers is identified if the magnitude of DREN(p), in an order among the category-to-object-document-relevance-evaluation numbers DREN(1), . . . , DREN(p), . . . , DREN(u), is within an order-criteria range. For example, if the order-criteria range is “the biggest”, and DREN(P) is the biggest among the category-to-object-document-relevance-evaluation numbers DREN(1), . . . , DREN(p), . . . , DREN(u), then DREN(P) is the identified one of the category-to-object-document-relevance-evaluation numbers. For another example, if the order-criteria range is “no smaller than the second biggest”, and DREN(p) and DREN(q) are respectively the biggest and the second biggest among the category-to-object-document-relevance-evaluation numbers DREN(1), . . . , DREN(p), . . . , DREN(u), then both DREN(p) and DREN(q) are the identified ones of the category-to-object-document-relevance-evaluation numbers, and the object document can be classified into two document-categories.

Another scheme for embodying the document-category-assigning process comprises:
forming a first mathematical matrix M1, with rows thereof respectively constituted by the reference-number groups R(1), . . . , R(q), . . . , R(u), and with each column thereof constituted by ones of the keyword-to-document-category-relevance-referring numbers which correspond to one of the key words, i.e., with each row thereof constituted by the keyword-to-document-category-relevance-referring numbers KTRB(1,p), . . . , KTRB(m,p) all included in the same one reference-number group [R(p), for example], and with each column thereof constituted by the keyword-to-document-category-relevance-referring numbers KTRB(j,1), . . . , KTRB(j,u) all corresponding to the same one key word [KW(j), for example], ones of the keyword-to-document-category-relevance-referring numbers which are in different ones of the columns of the first mathematical matrix respectively correspond to different ones of the key words KW(1), . . . , KW(m), thereby the rows of the first mathematical matrix correspond to the reference-number groups R(1), . . . , R(q), . . . , R(u) in a way of one-to-one, and the columns of the first mathematical matrix correspond to the key words in a way of one-to-one, the columns of the first mathematical matrix reside from left to right in such a way that the key words corresponding thereto are in an arbitrarily selected order, i.e., if the key words are listed in an arbitrarily selected order KW(m), . . . , KW(2), KW(1), the columns of the first mathematical matrix respectively corresponding to the key words listed in the order KW(m), . . . , KW(2), KW(1) reside from left to right, while if the key words are listed in an arbitrarily selected order KW(1), KW(2), . . . , KW(m), the columns of the first mathematical matrix respectively corresponding to the key words listed in the order KW(1), KW(2), . . . , KW(m) residing from left to right;
computing the frequency each of the key words KW(1), . . . , KW(m) appears in an object document Dt, to obtain a plurality of frequency values F1t, F2t, . . . , Fmt respectively corresponding to different ones of the key words KW(1), . . . , KW(m);
forming a second mathematical matrix M2 composed of one column, which is constituted by the frequency values F1t, F2t, . . . , Fmt respectively located from top to bottom in such a way that the key words corresponding thereto are in the arbitrarily selected order, i.e., if the columns of the first mathematical matrix M1 reside from left to right in such a way that the key words respectively corresponding thereto are in an arbitrarily selected order [for example, KW(m), . . . , KW(2), KW(1)], then the key words respectively corresponding to the frequency values located from top to bottom in the second mathematical matrix M2 are in the same order KW(m), . . . , KW(2), KW(1); and
multiplying the first mathematical matrix M1 by the second mathematical matrix M2 to obtain a third mathematical matrix (M1×M2) composed of a plurality of category-to-object-document-relevance-evaluation numbers DREN(1), . . . , DREN(p), . . . , DREN(u) listed in one column, the category-to-object-document-relevance-evaluation numbers DREN(1), . . . , DREN(p), . . . , DREN(u) correspond to the document-category titles g(1), . . . , g(p), . . . , g(u) in a way of one-to-one;
identifying one [DREN(p), for example] of the category-to-object-document-relevance-evaluation numbers which meets a reference condition, as has been described hereinbefore;
assigning the object document Dt one [g(p), for example] of the document-category titles g(1), . . . , g(p), . . . , g(u) which the identified category-to-object-document-relevance-evaluation number DREN(p) corresponds to, as has been described hereinbefore, thereby the object document Dt is classified into a document-category entitled g(p).

In case the object document Dt includes only one key word KW, the document-category-assigning process can be simplified to comprise: computing the frequency the key word KW appears in the object document Dt, to obtain a frequency value Ft representing the frequency the key word KW appears in the object document Dt;
performing a mathematical operation \mathring{×}between the frequency value Ft and each of the keyword-to-document-category-relevance-referring numbers KTRB(i,1), KTRB(i,2), . . . , KTRB(i,u) corresponding to document-category titles g(1), g(2), . . . , g(u) in a way of one-to-one, and all corresponding to the key word KW (KTRB(i,1), KTRB(i,2), . . . , KTRB(i,u) are so selected from a plurality of keyword-to-document-category-relevance-referring numbers that KTRB(i,1), KTRB(i,2), . . . , KTRB(i,u) correspond to the key word KW), to obtain a plurality of category-to-object-document-relevance-evaluation numbers DREN(1)=Ft\mathring{×}KTRB(i,1), DREN(2)=Ft\mathring{×}KTRB(i,2), . . . , DREN(u)=Ft\mathring{×}KTRB(i,u) corresponding to document-category titles g(1), g(2), . . . , g(u) in a way of one-to-one;
identifying one [DREN(p), for example] of the category-to-object-document-relevance-evaluation numbers which meets a reference condition;
assigning the object document Dt one [g(p) in this case] of document-category titles g(1), . . . , g(u) which the identified category-to-object-document-relevance-evaluation number DREN(p) corresponds to, thereby the object document Dt is classified into a document-category entitled g(p).

In the document-category-assigning process above, if the reference condition is “larger than a category-judge-criteria-value” instead of being based on the order among the category-to-object-document-relevance-evaluation numbers, then the present invention provides an evaluation-number-normalizing process to make sure the reference condition can always be relied upon. The evaluation-number-normalizing process includes:
summing the category-to-object-document-relevance-evaluation numbers DREN(1), . . . , DREN(q), . . . , DREN(u), to obtain a summed-evaluation number SDREN; and
   dividing, by the summed-evaluation number SDREN, each of the category-to-object-document-relevance-evaluation numbers DREN(1), . . . , DREN(q), . . . , DREN(u), to obtain the magnitude of each of the category-to-object-document-relevance-evaluation numbers, i.e., to obtain [DREN(1)÷SDREN], . . . , [DREN(q)÷SDREN], . . . , [DREN(u)÷SDREN] as the magnitude of each of the category-to-object-document-relevance-evaluation numbers.

The descriptions above may be better understood by referring to the following Tables 1-8, Matrix M1, and Matrix M2, as well as the notes associated therewith.

In Table 1 below, record documents D1, D2, . . . , Dn are in a same-category group corresponding to a document-category title g(q), Fij represents the frequency the key word KW(i) appears in document Dj.

TABLE 1

| | KW(1) | KW(2) | . . . | . . . | KW(m) |
|---|---|---|---|---|---|
| D1 | F11 | F21 | . . . | . . . | Fm1 |
| D2 | F12 | F22 | . . . | . . . | Fm2 |
| . | . | . | | | . |
| . | . | . | | | . |
| . | . | . | | | . |
| Dn | F1n | F2n | . . . | . . . | Fmn |

Number of record documents D1, D2, . . . , Dn is n
SF1 = F11 + F12 + . . . + F1n; AF1 = SF1 ÷ n = KTRB(1, q)
SF2 = F21 + F22 + . . . + F2n; AF2 = SF2 ÷ n = KTRB(2, q)
.
.
.
SFm = Fm1 + Fm2 + . . . + Fmn; AFm = SFm ÷ n = KTRB(m, q)

In Table 2 below, D3, D4, . . . , Dp are in a same-category group corresponding to a document-category title g(s), Fij represents the frequency the key word KW(i) appears in document Dj.

TABLE 2

| | KW(1) | KW(2) | . . . | . . . | KW(m) |
|---|---|---|---|---|---|
| D3 | F13 | F23 | . . . | . . . | Fm3 |
| D4 | F14 | F24 | . . . | . . . | Fm4 |
| . | . | . | | | . |
| . | . | . | | | . |
| . | . | . | | | . |
| Dp | F1p | F2p | . . . | . . . | Fmp |

Assume: number of record documents D3, D4, . . . , Dp is m
SF1 = F13 + F14 + . . . + F1p; AF1 = SF1 ÷ m = KTRB(1, s)
SF2 = F23 + F24 + . . . + F2p; AF2 = SF2 ÷ m = KTRB(2, s)
.
.
.
SFm = Fm3 + Fm4 + . . . + Fmp; AFm = SFm ÷ m = KTRB(m, s)

In Table 3 below, D1, D2, . . . , Dn are in a same-category group corresponding to a document-category title g(q), TN(j,k) represents the times the key word KW(j) appears in document Dk, where j=1, 2, 3, 4, 5, and k=1, . . . , n.

TABLE 3

| | KW(1) | KW(2) | KW(3) | KW(4) | KW(5) |
|---|---|---|---|---|---|
| D1 | TN(1, 1) = 10 | TN(2, 1) = 12 | TN(3, 1) = 38 | TN(4, 1) = 0 | TN(5, 1) = 0 |
| . . . | . . . | . . . | . . . | . . . | . . . |
| . . . | . . . | . . . | . . . | . . . | . . . |
| Dn | TN(1, n) = 0 | TN(2, n) = 10 | TN(3, n) = 32 | TN(4, n) = 26 | TN(5, n) = 9 |

STND1 = TN(1, 1) + TN(2, 1) + TN(3, 1) + TN(4, 1) + TN(5, 1) =
10 + 12 + 38 + 0 + 0
.
.
.
STNDn = TN(1, n) + TN(2, n) + TN(3, n) + TN(4, n) + TN(5, n) =
0 + 10 = 32 = 26 = 9
F1D1 = TN(1, 1) ÷ STND1 = 10 ÷ (10 + 12 + 38 + 0 + 0) = 0.166
F2D1 = TN(2, 1) ÷ STND1 = 12 ÷ (10 + 12 + 38 + 0 + 0) = 0.2
F3D1 = TN(3, 1) ÷ STND1 = 38 ÷ (10 + 12 + 38 + 0 + 0) = 0.633
F4D1 = TN(4, 1) ÷ STND1 = 0 ÷ (10 + 12 + 38 + 0 + 0) = 0
F5D1 = TN(5, 1) ÷ STND1 = 0 ÷ (10 + 12 + 38 + 0 + 0) = 0
F1Dn = TN(1, n) ÷ STNDn = 0 ÷ (0 +10 + 32 + 26 + 9) = 0
F2Dn = TN(2, n) ÷ STNDn = 10 ÷ (0 +10 + 32 + 26 + 9) = 0.13
F3Dn = TN(3, n) ÷ STNDn = 32 ÷ (0 +10 + 32 + 26 + 9) = 0.415
F4Dn = TN(4, n) ÷ STNDn = 26 ÷ (0 +10 + 32 + 26 + 9) = 0.337
F5Dn = TN(5, n) ÷ STNDn = 9 ÷ (0 +10 + 32 + 26 + 9) = 0.117
Number of record documents D1, . . . , Dn is n
SF1 = F1D1 + . . . + F1Dn = 0.166 + . . . + 0;
Af1 = SF1 ÷ n = (0.166 + . . . + 0) ÷ n = KTRB(1, q)
SF2 = F2D1 + . . . + F2Dn = 0.2 + . . . + 0.13
Af2 = SF2 ÷ n = (0.2 + . . . + 0.13) ÷ n = KTRB(2, q)
SF3 = F3D1 + . . . + F3Dn = 0.633 + . . . + 0.415
Af3 = SF3 ÷ n = (0.633 + . . . + 0.415) ÷ n = KTRB(3, q)
SF4 = F4D1 + . . . + F4Dn = 0 + . . . + 0.337
Af4 = SF4 ÷ n = (0 + . . . + 0.337) ÷ n = KTRB(4, q)
SF5 = F5D1 + . . . + F5Dn = 0 + . . . + 0.117
Af5 = SF5 ÷ n = (0 + . . . + 0.117) ÷ n = KTRB(5, q)

all listed on Table 4 below.

TABLE 4

| | | Key Words | | | | |
|---|---|---|---|---|---|---|
| | | KW(1) | KW(2) | KW(3) | KW(4) | KW(5) |
| g(q) | D1 | F1D1 = | F2D1 = | F3D1 = | F4D1 = | F5D1 = |
| | | 10 ÷ (10 + 12 + | 12 ÷ (10 + 12 + | 38 ÷ (10 + 12 + | 0 ÷ (10 + 12 + | 0 ÷ (10 + 12 + |
| | | 38 + 0 + 0) = | 38 + 0 + 0) = | 38 + 0 + 0) = | 38 + 0 + 0) = | 38 + 0 + 0) = |
| | | 0.166 | 0.2 | 0.633 | 0 | 0 |
| | . | . | . | . | . | . |
| | . | . | . | . | . | . |
| | . | . | . | . | . | . |
| | Dn | F1Dn = | F2Dn = | F3Dn = | F4Dn = | F5Dn = |
| | | 0 ÷ (0 + 10 + | 10 ÷ (0 + 10 + | 32 ÷ (0 + 10 + | 26 ÷ (0 + 10 + | 9 ÷ (0 + 10 + |
| | | 32 + 26 + 9) = | 32 + 26 + 9) = | 32 + 26 + 9) = | 32 + 26 + 9) = | 32 + 26 + 9) = |
| | | 0 | 0.13 | 0.415 | 0.337 | 0.117 |
| | | Af1 = SF1 ÷ n = | Af2 = SF2 ÷ n = | Af3 = SF3 ÷ n = | Af4 = SF4 ÷ n = | Af5 = SF5 ÷ n = |
| | | (0.166 + . . . + | (0.2 + . . . + | (0.633 + . . . + | (0 + . . . + | (0 + . . . + |
| | | 0) ÷ n = | 0.13) ÷ n = | 0.415) ÷ n = | 0.337) ÷ n = | 0.117) ÷ n = |
| | | KTRB(1, q) | KTRB(2, q) | KTRB(3, q) | KTRB(4, q) | KTRB(5, q) |

Repeating the above steps for each q where q=1, . . . , u, a plurality of keyword-to-document-category-relevance-referring numbers listed on Table 5 below are obtained.

TABLE 5

| | KW(1) | . . . | KW(j) . . . | KW(m) |
|---|---|---|---|---|
| g(1) | KTRB(1, 1) | . . . | KTRB(j, 1) . . . | . . . KTRB(m, 1) |
| . | . | . | . | . |
| . | . | . | . | . |
| . | . | . | . | . |
| g(q) | KTRB(1, q) | . . . | KTRB(j, q) . . . | . . . KTRB(m, q) |
| . | . | . | . | . |
| . | . | . | . | . |
| . | . | . | . | . |
| g(u) | KTRB(1, u) | . . . | KTRB(j, u) . . . | . . . KTRB(m, u) |

All the keyword-to-document-category-relevance-referring numbers on each row of table 5 correspond to the same one document-category title. For example, KTRB(1,1), . . . KTRB(m,1) all correspond to document-category title g(1); KTRB(1,q), . . . KTRB(m,q) all correspond to document-category title g(q).

Another scheme for obtaining the plurality of keyword-to-document-category-relevance-referring numbers is represented by Table 6 bolow, where NWK is number of the words in the same-category group g(q) of record documents, i.e., NWK is number of the total words in all of the record documents D1, . . . , Dn classified into same-category group g(q).

TABLE 6

| | | Key Words | | | | |
|---|---|---|---|---|---|---|
| | | KW(1) | KW(2) | KW(3) | KW(4) | KW(5) |
| g(q) | D1 | F1D1 = | F2D1 = | F3D1 = | F4D1 = | F5D1 = |
| | | 10 ÷ NWK | 12 ÷ NWK | 38 ÷ NWK | 0 ÷ NWK | 0 ÷ NWK |
| | . | . | . | . | . | . |
| | . | . | . | . | . | . |
| | . | . | . | . | . | . |
| | Dn | F1Dn = | F2Dn = | F3Dn = | F4Dn = | F5Dn = |
| | | 0 ÷ NWK | 10 ÷ NWK | 32 ÷ NWK | 26 ÷ NWK | 9 ÷ NWK |
| | | Af1 = | Af2 = | Af3 = | Af4 = | Af5 = |
| | | (10 + . . . + | (0.2 + . . . + | (0.633 + . . . + | (0 + . . . + | (0 + . . . + |
| | | 0) ÷ NWK = | 0.13) ÷ NWK = | 0.415) ÷ NWK = | 0.337) ÷ NWK = | 0.117) ÷ NWK = |
| | | KTRB(1, q) | KTRB(2, q) | KTRB(3, q) | KTRB(4, q) | KTRB(5, q) |

A plurality of frequency values F1t, F2t, . . . , Fmt representing the frequencies the key words KW(1), . . . , KW(m) appear in object document Dt, are listed on Table 7 below.

TABLE 7

| KW(1) | . . . | KW(j) . . . | KW(m) |
|---|---|---|---|
| Flt | . . . | Fjt . . . | Fmt |

Table 8 below lists a plurality of category-to-object-document-relevance-evaluation numbers DREN(1), . . . , DREN(q), . . . , DREN(u) obtained by performing mathematical operations \mathring{×} and ⊕ between the keyword-to-document-category-relevance-referring numbers listed on Table 5 and the frequency values listed on Table 7

TABLE 8

| | |
|---|---|
| DREN(1) = | Flt [symbol] KTRB(1, 1) ⊕ . . . ⊕ Fjt [symbol] KTRB(j, 1) ⊕ . . . |
| | ⊕ Fmt [symbol] KTRB(m, 1) |
| . | . |
| . | . |
| . | . |
| . | . |
| . | . |
| . | . |
| DREN(q) = | Flt [symbol] KTRB(1, q) ⊕ . . . ⊕ Fjt [symbol] KTRB(j, q) ⊕ . . . |
| | ⊕ Fmt [symbol] KTRB(m, q) |
| . | . |
| . | . |
| . | . |
| DREN(u) = | Flt [symbol] KTRB(1, u) ⊕ . . . ⊕ Fjt [symbol] KTRB(j, u) ⊕ . . . |
| | ⊕ Fmt [symbol] KTRB(m, u) |

The category-to-object-document-relevance-evaluation numbers DREN(1), . . . , DREN(u) may also be obtained by performing matrix operation (multiplication) between a matrix M1 and a matrix M2 as shown below.

$$M1 = {[ \begin{matrix}KTRB ( 1 , 1 ) & … & KTRB ( j , 1 ) … & KTRB ( m , 1 ) \\ KTRB ( 1 , 2 ) & … & KTRB ( j , 2 ) … & KTRB ( m , 2 ) \\ … & … & … & … \\ KTRB ( 1 , u ) & … & KTRB ( 2 , u ) & KTRB ( m , u )\end{matrix} ]}_{uXm m}$$

$$M2 = [ \begin{matrix}F1t \\ F2t \\ … \\ Fmt\end{matrix} ]$$

$$M1 \times M2 = \begin{matrix}F1t ⊗ KTRB ( 1 , 1 ) ⊕ F2t ⊗ KTRB ( 2 , 1 ) ⊕ … ⊕ Fmt ⊗ KTRB ( m , 1 ) \\ F1t ⊗ KTRB ( 1 , 2 ) ⊕ F2t ⊗ KTRB ( 2 , 2 ) ⊕ … ⊕ Fmt ⊗ KTRB ( m , 2 ) \\ … \\ … \\ F1t ⊗ KTRB ( 1 , u ) ⊕ F2t ⊗ KTRB ( 2 , u ) ⊕ … ⊕ Fmt ⊗ KTRB ( m , u )\end{matrix} = \begin{matrix}DREN ( 1 ) \\ DREN ( 2 ) \\ … \\ DREN ( u )\end{matrix}$$

Tables 9, 10, and 11 below, as a whole, represent a specific example characterizing Tables 5, 7, and 8 above, and are to illustrate main features of the document-category-assigning process provided by the present invention.

TABLE 9

| | KW(1) | KW(2) | KW(3) |
|---|---|---|---|
| g(1) | KTRB(1, 1) = 0.2 | KTRB(2, 1) = 0.25 | KTRB(3, 1) = 0.3 |
| g(2) | KTRB(1, 2) = 0.3 | KTRB(2, 2) = 0.2 | KTRB(3, 2) = 0.1 |
| g(3) | KTRB(1, 3) = 0.15 | KTRB(2, 3) = 0.3 | KTRB(3, 3) = 0.2 |
| g(4) | KTRB(1, 4) = 0.05 | KTRB(2, 4) = 0.1 | KTRB(3, 4) = 0.2 |

TABLE 10

| KW(1) | KW(2) | KW(3) |
|---|---|---|
| Fit = 8 | F2t = 2 | F3t = 6 |

Frequency values 8, 2, and 6 above respectively represent the frequencies the key words KW(1), KW(2), KW(3) appear in object document Dt.

TABLE 11
DREN(1) = 0.2 × 8 + 0.25 × 2 + 0.3 × 6 = 3.9 [magnitude of DREN(1)]
DREN(2) = 0.3 × 8 + 0.2 × 2 + 0.1 × 6 = 3.4 [magnitude of DREN(2)]
DREN(3) = 0.15 × 8 + 0.3 × 2 + 0.2 × 6 = 3.0 [magnitude of DREN(3)]
DREN(4) = 0.05 × 8 + 0.1 × 2 + 0.2 × 6 = 1.8 [magnitude of DREN(4)]

If the reference condition is such that one category-to-object-document-relevance-evaluation number is identified if the magnitude thereof, in an order among the category-to-object-document-relevance-evaluation numbers DREN(1), DREN(2), DREN(3), DREN(4) is the biggest, then DREN(1) is identified, and object document Dt is classified into a document-category entitled g(1) which corresponds to DREN(1). If the reference condition is “larger than a category-judge-criteria-value” instead of being based on the order among the category-to-object-document-relevance-evaluation numbers, then the magnitudes 3.9, 3.4, 3.0, and 1.8 of DREN(1), DREN(2), DREN(3), and DREN(4) had better be normalized, for example, by an evaluation-number-normalizing process, to make sure the reference condition can always be relied upon. The normalized magnitudes are 3.9÷(3.9+3.4+3.0+1.8), 3.4÷(3.9+3.4+3.0+1.8), 3.0÷(3.9+3.4+3.0+1.8), and 1.8÷(3.9+3.4+3.0+1.8). Assume the category-judge-criteria-value is set to be 0.32, then only 3.9÷(3.9+3.4+3.0+1.8) is larger than 0.32, and DREN(1) is identified, thereby object document Dt is classified into a document-category entitled g(1) which corresponds to DREN(1).

The method provided by the present invention may further comprise a key-word-identification process for identifying the key words in an arbitrary document (including the object document). The key-word-identification process may comprise:
counting the frequency each word of the arbitrary document appears in the arbitrary document, to obtain an appearing frequency of each word of the arbitrary document; designating an arbitrary word of the arbitrary document as a candidate key word if the appearing frequency of the arbitrary word meets a reference condition; searching a key-word-reference database for a reference code corresponding to the candidate key word; and determining, in case the reference code is searched out, whether or not the candidate key word is a key word according to an attribute of the reference code. The aforementioned reference condition means “larger than a key-word-criteria value”, i.e., the arbitrary word of the arbitrary document is designated as a candidate key word if the appearing frequency of the arbitrary word is larger than the key-word-criteria value (0.9 or 0.73, just for example). One way to choose the key-word-criteria value is to let it equal to the average of the appearing frequencies of all the words of the arbitrary document. Alternatively the aforementioned reference condition means “within a frequency-order-criteria-range”, i.e., the arbitrary word of the arbitrary document is designated as a candidate key word if the appearing frequency of the arbitrary word, in order of magnitude among the appearing frequencies of all the words of the arbitrary document, is within a frequency-order-criteria-range. For example, in case the frequency-order-criteria-range is 1-2, and the appearing frequencies of all the words of the arbitrary document are 0.3, 0.65, 0.5, 0.7, 0.4, 0.8, 0.75, 0.85, and many others lower than 0.3, the arbitrary word of the arbitrary document is designated as a candidate key word if the appearing frequency of the arbitrary word is the highest (0.85 in this case) or the second highest one (0.8 in this case) among all the appearing frequencies.

According to the category-classification process provided by the present invention and described above, the key-word-reference database is configured to contain a plurality of reference codes. The reference code corresponding to a candidate key word includes the candidate key word. The reference code also includes an attribute represented by a first symbol or a second symbol. The candidate key word is determined to be a key word if the attribute of the reference code is represented by the first symbol, while determined to be not a key word if the attribute of the reference code is represented by the second symbol. For example, if the candidate key word is the words “investment risk” and the reference code is “investment risk +” with its attribute represented by a first symbol “+”, the candidate key word is determined to be a key word, while determined to be not a key word if the reference code is “investment risk −” with its attribute represented by a second symbol “−”. The reference code may include one or more than word in addition to an attribute.

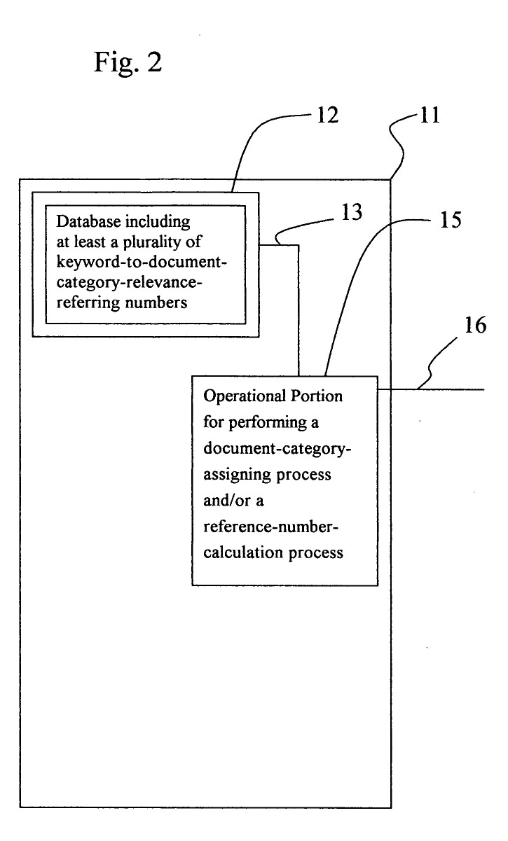

The present invention may also be embodied as an apparatus 11 (in FIG. 2) applied to an information management system in which at least one of a plurality of document-category titles g(1), . . . , g(u) is assigned to an object document Dt that includes at least two key words KW(1), . . . , KW(m). The apparatus 11 comprises a data-storage portion 12 having a database residing thereon, the database comprising:
a plurality of key-word-codes respectively representing different ones of the key words KW(1), . . . , KW(m);
a plurality of category-codes respectively representing different ones of document-category titles g(1), . . . , g(u); and
a plurality of keyword-to-document-category-relevance-referring numbers each [i.e., KTRB(i,p) where i=1, 2, . . . ,m, and p=1, 2, . . . , u] corresponding to one key word KW(i) and to one document-category title g(p), one of the keyword-to-document-category-relevance-referring numbers which corresponds to an arbitrarily selected key word [KW(j) where j=1, 2, . . . , m] and to an arbitrarily selected document-category title [g(q) where q=1, 2, . . . , u] represents or relates to the probability the arbitrarily selected key word KW(j) appears in a document with the arbitrarily selected document-category title g(q), i.e., represents or relates to the probability the arbitrarily selected appears in a document (the object document or another ones) which is classified into a document-category entitled g(q).

Alternatively the database according to the present invention may comprise:
a plurality of key-word-codes respectively representing different ones of the key words KW(1), . . . , KW(m);
a plurality of category-codes respectively representing different ones of the document-category titles g(1), . . . , g(u); and
a first mathematical matrix M1, with rows thereof respectively constituted by the reference-number groups R(1), . . . , R(q), . . . , R(u), and with each column thereof constituted by ones of the keyword-to-document-category-relevance-referring numbers which correspond to one (the same one) of the key words, i.e., with each row thereof constituted by the keyword-to-document-category-relevance-referring numbers KTRB(1,p), . . . , KTRB(m,p) all included in the same one reference-number group [R(p), for example], and with each column thereof constituted by the keyword-to-document-category-relevance-referring numbers KTRB(j,1), . . . , KTRB(j,u) all corresponding to the same one key word [KW(j), for example], ones of the keyword-to-document-category-relevance-referring numbers which are in different ones of the columns of the first mathematical matrix respectively correspond to different ones of the key words KW(1), . . . , KW(m), thereby the rows of the first mathematical matrix correspond to the reference-number groups R(1), . . . , R(q), . . . , R(u) in a way of one-to-one, and the columns of the first mathematical matrix correspond to the key words in a way of one-to-one, the columns of the first mathematical matrix reside from left to right in such a way that the key words corresponding thereto are in an arbitrarily selected order, i.e., if the key words are listed in an arbitrarily selected order KW(m), . . . , KW(2), KW(1), the columns of the first mathematical matrix respectively corresponding to the key words listed in the order KW(m), . . . , KW(2), KW(1) reside from left to right, while if the key words are listed in an arbitrarily selected order KW(1), KW(2), . . . , KW(m), the columns of the first mathematical matrix respectively corresponding to the key words listed in the order KW(1), KW(2), . . . , KW(m) reside from left to right; and
a second mathematical matrix M2 composed of one column, which is constituted by the frequency values F1t, F2t, . . . , Fmt respectively located from top to bottom in such a way that the key words corresponding thereto are in the arbitrarily selected order, i.e., if the columns of the first mathematical matrix M1 reside from left to right in such a way that the key words respectively corresponding thereto are in an arbitrarily selected order [for example, KW(m), . . . , KW(2), KW(1)], then the key words respectively corresponding to the frequency values located from top to bottom in the second mathematical matrix M2 are in the same order KW(m), . . . , KW(2), KW(1).

In the apparatus 11 provided by the present invention, the database may further comprise a plurality of frequency values respectively representing the frequencies the key words KW(1), . . . , KW(m) appear in the plurality of record documents D, . . . , Dy to which at least one of the document-category titles g(1), . . . , g(u) has been assigned, i.e., the database further comprises frequency values F11, F21, F31, . . . , Fm1 respectively representing the frequencies the key words KW(1), . . . , KW(m) appear in record documents D1, and frequency values F12, F22, F32, . . . , Fm2 respectively representing the frequencies the key words KW(1), . . . , KW(m) appear in record documents D2, or in other words, comprises frequency values F1v, F2v, F3v, . . . , Fmv respectively representing the frequencies the key words KW(1), . . . , KW(m) appear in record documents Dv where v=1, 2, . . . , y.

Alternatively, in the apparatus 11 provided by the present invention, the database may further comprise a plurality of times-numbers respectively representing the times the key words KW(1), . . . , KW(m) appear in the plurality of record documents D1, . . . , Dy to which at least one of the document-category titles g(1), . . . , g(u) has been assigned.

The apparatus 11 provided by the present invention may further comprise an operational portion 15 (shown in FIG. 2) for computing the frequency values F1v, F2v, F3v, . . . , Fmv, to obtain the keyword-to-document-category-relevance-referring numbers KTRB(i,p) where i=1, 2, . . . , m, and p=1, 2, . . . , u, as described hereinbefore. The frequency values F1v, F2v, F3v, . . . , Fmv for v=1, 2, . . . , w respectively represent the frequencies the key words KW(1), . . . , KW(m) appear in record documents D1, . . . , Dy, as described hereinbefore. Alternatively the operational portion 15 may be used to compute the aforementioned times-numbers to obtain the keyword-to-document-category-relevance-referring numbers KTRB(i,p) where i=1, 2, . . . ,m, and p=1, 2, . . . , u, the times-numbers respectively represent the times the key words KW(1), . . . , KW(m) appear in the plurality of record documents D1, . . . , Dy to which at least one of the document-category titles g(1), . . . , g(u) has been assigned.

The operational portion 15 according to the present invention may have a program residing therein, and the database according to the present invention further comprises the plurality of record documents D1, . . . , Dy. The program is for performing any of the reference-number-calculation processes described hereinbefore.

The operational portion 15 according to the present invention may also be for performing any of the document-category-assigning processes described hereinbefore.

The database according to the present invention may further comprise the aforementioned category-judge-criteria-value, and the operational portion 15 according to the present invention is such that a category-to-object-document-relevance-evaluation number DREN(j) is identified if the magnitude of the DREN(j), in an order among the category-to-object-document-relevance-evaluation numbers DREN(1), . . . , DREN(j), . . . , DREN(u), is larger than the category-judge-criteria-value.

Apparatus 11 (as shown in FIG. 2) may further comprise an access channel 13 for the operational portion 15 to access the database residing on the data-storage portion 12. Apparatus 11 may still further comprise a communication channel 16 for the operational portion 15 and/or the data-storage portion 12 to communicate with related administrator/user, and/or a computer, and/or Internet (or another networks).

While the invention has been described in terms of what are presently considered to be the most practical and preferred schemes or embodiments, it shall be understood that the invention is not limited to the disclosure. On the contrary, it is to cover various modifications or similar arrangements suggested by the disclosure or included within the spirit and scope of the appended claims.

1. A method of classifying documents, comprising a document-category-assigning process for assigning, according to a plurality of reference-number groups, at least one of a plurality of document-category titles to an object document, wherein said object document includes at least two key words, said reference-number groups correspond to said document-category titles in a way of one-to-one, each of said reference-number groups includes a plurality of keyword-to-document-category-relevance-referring numbers corresponding to said key words in a way of one-to-one, said document-category-assigning process comprising:
computing a frequency each of said key words appears in said object document, to obtain a plurality of frequency values corresponding to said key words in a way of one-to-one, and thereby being corresponded, in a way of one-to-one, by said keyword-to-document-category-relevance-referring numbers which are included in each of said reference-number groups;
performing a first mathematical operation between each of said frequency values and each of said keyword-to-document-category-relevance-referring number which corresponds thereto, to obtain a plurality of first-operation-result groups each including a plurality of first-operation numbers which result from said first mathematical operation and respectively correspond to different ones of the keyword-to-document-category-relevance-referring numbers included in one of said reference-number groups, thereby said first-operation-result groups correspond to said document-category titles in a way of one-to-one;
for each of said first-operation-result groups, performing a second mathematical operation among the first-operation numbers therein, to obtain a plurality of category-to-object-document-relevance-evaluation numbers respectively corresponding to different ones of said document-category titles;
identifying one of said category-to-object-document-relevance-evaluation numbers which meets a reference condition;
assigning said object document one of said document-category titles which the identified one of said category-to-object-document-relevance-evaluation numbers corresponds to.

2. The method according to claim 1 wherein said first mathematical operation is multiplication, and said second mathematical operation is addition.

3. The method according to claim 1 wherein said reference condition is such that one of said category-to-object-document-relevance-evaluation numbers is identified if the magnitude thereof is larger than a category-judge-criteria-value.

4. The method according to claim 1 wherein said reference condition is such that one of said category-to-object-document-relevance-evaluation numbers is identified if the magnitude thereof, in an order among said category-to-object-document-relevance-evaluation numbers, is within an order-criteria range.

5. The method according to claim 1 wherein one of said keyword-to-document-category-relevance-referring numbers which corresponds to an arbitrarily selected one of said key words, and is included in one of said reference-number groups that corresponds to an arbitrarily selected one of said document-category titles, relates to the probability the arbitrarily selected one of said key words appears in a document with the arbitrarily selected one of said document-category titles.

6. The method according to claim 1 further comprising a reference-number-calculation process for obtaining said reference-number groups, according to a record file including a plurality of record documents each corresponding to at least one of said document-category titles, said reference-number-calculation process comprising the steps of:
(n) identifying a same-category group of record documents among said record documents in such a way that said same-category group of record documents correspond to an arbitrarily selected one of said document-category titles;
(o) counting the number of the record documents in said same-category group of record documents, to obtain a document-of same-category number;
(p) computing the frequencies an arbitrarily selected one of said key words appears in said same-category group of record documents, to obtain a plurality of frequency values respectively representing the frequencies the arbitrarily selected one of said key words appears in said same-category group of record documents;
(q) summing said frequency values to obtain a summed frequency number, and dividing said summed frequency number by said document-of same-category number to obtain an average-frequency that is one of said keyword-to-document-category-relevance-referring numbers which corresponds to the arbitrarily selected one of said key words and to the arbitrarily selected one of said document-category titles.

7. The method according to claim 6 further comprising:
repeating the step of (a), (b), (c), and (d) for different ones of said document-category titles and for different ones of said key words, until said reference-number groups are obtained.

8. The method according to claim 1 further comprising a reference-number-calculation process for obtaining said reference-number groups, according to a record file including a plurality of record documents each corresponding to at least one of said document-category titles, said reference-number-calculation process comprising the steps of:
(r) identifying a same-category group of record documents among said record documents in such a way that said same-category group of record documents correspond to an arbitrarily selected one of said document-category titles;
(s) counting the number of the record documents in said same-category group, to obtain a document-of same-category number;
(t) computing the times each of said key words appears in an arbitrarily selected one of the record documents in said same-category group, to obtain a plurality of times-numbers respectively representing the times said key words appear in the arbitrarily selected one of the record documents in said same-category group;
(u) summing said times-numbers to obtain a summed times-number, and dividing an arbitrarily selected one of said times-numbers by said summed times-number to obtain a frequency value representing the frequency a corresponding one of said key words appears in the arbitrarily selected one of the record documents in said same-category group, wherein the corresponding one of said key words is the one of said key words which corresponds to the arbitrarily selected one of said times-numbers;
(v) repeating the steps of (g) and (h) for different ones of the record documents in said same-category group, until a plurality of frequency values are obtained wherein said frequency values respectively represent the frequencies the corresponding one of said key words appears in different ones of the record documents in said same-category group;
(w) summing said frequency values to obtain a summed frequency number, and dividing said summed frequency number by said document-of same-category number, to obtain one of said keyword-to-document-category-relevance-referring numbers which corresponds to the one of said key words and to the arbitrarily selected one of said document-category titles.

9. The method according to claim 1 further comprising a reference-number-calculation process for obtaining said reference-number groups, according to a record file including a plurality of record documents each corresponding to at least one of said document-category titles, said reference-number-calculation process comprising the steps of:
(x) identifying a same-category group of record documents among said record documents in such a way that said same-category group of record documents correspond to an arbitrarily selected one of said document-category titles;
(y) counting the number of words in said same-category group of record documents, to obtain a document-of same-category-word-total number;
(z) computing the times an arbitrarily selected one of said key words appears in said same-category group of record documents, to obtain a times-number corresponding to the arbitrarily selected one of said key words, and dividing said times-number by said document-of same-category-word-total number, to obtain one of said keyword-to-document-category-relevance-referring numbers which corresponds to the arbitrarily selected one of said key words and to the arbitrarily selected one of said document-category titles.

10. The method according to claim 6 further comprising a reference-number-adjusting process which includes:
in case one of said frequency values differs from said average-frequency by a difference-amount larger an adjust-criteria value, adjusting the one of said frequency values to be a value differing from said average-frequency by said adjust-criteria value.

11. The method according to claim 6 further comprising a reference-number-adjusting process which includes:
in case one of said frequency values exceeds said average-frequency by a difference larger than a first adjust-criteria value, reducing the one of said frequency values by a first-adjusting amount;
in case one of said frequency values is lesser than said average-frequency by a difference larger than a second adjust-criteria value, increasing the one of said frequency values by a second-adjusting amount.

12. The method according to claim 3 further comprising an evaluation-number-normalizing process which includes:
summing said category-to-object-document-relevance-evaluation numbers to obtain a summed-evaluation number; and
dividing, by said summed-evaluation number, each of said category-to-object-document-relevance-evaluation numbers to obtain the magnitude of each of said category-to-object-document-relevance-evaluation numbers.

13. The method according to claim 1 further comprising a key-word-identification process for identifying said key words, said key-word-identification process comprising:
counting the frequency each word code of said object document appears in said object document, to obtain an appearing frequency of each word code of said object document;
designating one word code of said object document as a candidate key word code if the appearing frequency of the one word code meets a key-word-reference condition; and
searching a key-word-reference database for a reference code corresponding to said candidate key word code, and determining, in case said reference code is searched out, whether or not said candidate key word code is the key word code according to an attribute of said reference code.

14. A method of classifying documents, comprising a document-category-assigning process for assigning, according to a plurality of reference-number groups, at least one of a plurality of document-category titles to an object document, wherein said object document includes at least two key words, said reference-number groups correspond to said document-category titles in a way of one-to-one, each of said reference-number groups includes a plurality of keyword-to-document-category-relevance-referring numbers corresponding to said key words in a way of one-to-one, said document-category-assigning process comprising:
forming a first mathematical matrix with rows thereof respectively constituted by said reference-number groups, with each column thereof constituted by ones of said keyword-to-document-category-relevance-referring numbers which correspond to one of said key words, ones of said keyword-to-document-category-relevance-referring numbers which are in different ones of the columns of said first mathematical matrix respectively correspond to different ones of said key words, thereby the columns of said first mathematical matrix correspond to said key words in a way of one-to-one, the columns of said first mathematical matrix reside from left to right in such a way that the ones of said key words corresponding thereto are in an arbitrarily selected order;
computing the frequency each of said key words appears in said object document, to obtain a plurality of frequency values respectively corresponding to different ones of said key words;
forming a second mathematical matrix composed of one column which is constituted by said frequency values respectively located from top to bottom in such a way that the ones of said key words corresponding thereto are in said arbitrarily selected order; and
multiplying said first mathematical matrix by said second mathematical matrix to obtain a third mathematical matrix composed of a plurality of category-to-object-document-relevance-evaluation numbers listed in one column, said category-to-object-document-relevance-evaluation numbers correspond to said document-category titles in a way of one-to-one;
identifying one of said category-to-object-document-relevance-evaluation numbers which meets a reference condition;
assigning said object document one of said document-category titles which the identified one of said category-to-object-document-relevance-evaluation numbers corresponds to.

15. A method of classifying documents, comprising a document-category-assigning process for assigning, according to a plurality of keyword-to-document-category-relevance-referring numbers, at least one of a plurality of document-category titles to an object document, wherein said object document includes a key word, said keyword-to-document-category-relevance-referring numbers correspond to said document-category titles in a way of one-to-one, said document-category-assigning process comprising:
computing a frequency said key word appears in said object document, to obtain a frequency value representing the frequency said key word appears in said object document;
performing a mathematical operation between said frequency value and each of said keyword-to-document-category-relevance-referring number, to obtain a plurality of category-to-object-document-relevance-evaluation numbers corresponding to said document-category titles in a way of one-to-one;
identifying one of said category-to-object-document-relevance-evaluation numbers which meets a reference condition;
assigning said object document one of said document-category titles which the identified one of said category-to-object-document-relevance-evaluation numbers corresponds to.

16. The method according to claim 15 wherein one of said keyword-to-document-category-relevance-referring numbers which corresponds to an arbitrarily selected one of said document-category titles, represents the probability said key words appears in a document with the arbitrarily selected one of said document-category titles.

17. An apparatus applied to an information management system in which at least one of a plurality of document-category titles is assigned to an object document that includes at least two key words, said apparatus comprising a data-storage portion having a database residing thereon, said database comprising:
a plurality of key-word-codes respectively representing different ones of said key words;
a plurality of category-codes respectively representing different ones of said document-category titles; and
a plurality of keyword-to-document-category-relevance-referring numbers each corresponding to one of said key words and to one of said document-category titles, one of said keyword-to-document-category-relevance-referring numbers which corresponds to an arbitrarily selected one of said key words and to an arbitrarily selected one of said document-category titles relates to the probability the arbitrarily selected one of said key words appears in a document with the arbitrarily selected one of said document-category titles.

18. The apparatus according to claim 17 wherein said database further comprises:
a plurality of frequency values respectively representing the frequencies said key words appear in a plurality of record documents to which at least one of said document-category titles has been assigned.

19. The apparatus according to claim 17 wherein said database further comprises:
a plurality of times-numbers respectively representing the times said key words appear in a plurality of record documents to which at least one of said document-category titles has been assigned.

20. The apparatus according to claim 18 further comprising an operational portion for computing said frequency values to obtain said keyword-to-document-category-relevance-referring numbers.

21. The apparatus according to claim 19 further comprising an operational portion for computing said times-numbers to obtain said keyword-to-document-category-relevance-referring numbers.

22. The apparatus according to claim 17 further comprising an operational portion having a program residing therein, wherein said database further comprises a plurality of record documents, and said program is for:
identifying a same-category group of record documents among said record documents in such a way that said same-category group of record documents correspond to an arbitrarily selected one of said document-category titles;
counting the number of the record documents in said same-category group, to obtain a document-of same-category number;
computing the frequencies an arbitrarily selected one of said key words appears in said same-category group of record documents, to obtain a plurality of frequency values representing the frequencies the arbitrarily selected one of said key words appears in said same-category group of record documents;
summing said frequency values to obtain a summed frequency number, and dividing said summed frequency number by said document-of same-category number, to obtain an average-frequency that is one of said keyword-to-document-category-relevance-referring numbers which corresponds to the arbitrarily selected one of said key words and to the arbitrarily selected one of said document-category titles.

23. The apparatus according to claim 17 further comprising an operational portion having a program residing therein, wherein said database further comprises a plurality of record documents, and said program is for performing the steps of:
(aa) identifying a same-category group of record documents among said record documents in such a way that said same-category group of record documents correspond to an arbitrarily selected one of said document-category titles;
(bb) counting the number of the record documents in said same-category group, to obtain a document-of same-category number;
(cc) computing the times each of said key words appears in an arbitrarily selected one of the record documents in said same-category group, to obtain a plurality of times-numbers respectively representing the times said key words appear in the arbitrarily selected one of the record documents in said same-category group;
(dd) summing said times-numbers to obtain a summed times-number, and dividing an arbitrarily selected one of said times-numbers by said summed times-number to obtain a frequency value representing the frequency a corresponding one of said key words appears in the arbitrarily selected one of the record documents in said same-category group, wherein the corresponding one of said key words is the one of said key words which corresponds to the arbitrarily selected one of said times-numbers;
(ee) repeating the steps of (p) and (q) for different ones of the record documents in said same-category group, until a plurality of frequency values are obtained wherein said frequency values respectively represent the frequencies the corresponding one of said key words appears in different ones of the record documents in said same-category group;
(ff) summing said frequency values to obtain a summed frequency number, and dividing said summed frequency number by said document-of same-category number, to obtain one of said keyword-to-document-category-relevance-referring numbers which corresponds to the one of said key words and to the arbitrarily selected one of said document-category titles.

24. The apparatus according to claim 17 further comprising an operational portion having a program residing therein, wherein said database further comprises a plurality of record documents, and said program is for:
identifying a same-category group of record documents among said record documents in such a way that said same-category group of record documents correspond to an arbitrarily selected one of said document-category titles;
counting the number of words in said same-category group of record documents, to obtain a document-of same-category-word-total number;
computing the times an arbitrarily selected one of said key words appears in said same-category group of record documents, to obtain a times-number corresponding to the arbitrarily selected one of said key words, and dividing said times-number by said document-of same-category-word-total number, to obtain one of said keyword-to-document-category-relevance-referring numbers which corresponds to the arbitrarily selected one of said key words and to the arbitrarily selected one of said document-category titles.

25. The apparatus according to claim 17 further comprising an operational portion for:
computing a frequency each of said key words appears in said object document, to obtain a plurality of frequency values corresponding to said key words in a way of one-to-one, and thereby being corresponded, in a way of one-to-one, by said keyword-to-document-category-relevance-referring numbers which are included in each of said reference-number groups;
performing a first mathematical operation between each of said frequency values and each of said keyword-to-document-category-relevance-referring number which corresponds thereto, to obtain a plurality of first-operation-result groups each including a plurality of first-operation numbers which result from said first mathematical operation and respectively correspond to different ones of the keyword-to-document-category-relevance-referring numbers included in one of said reference-number groups, thereby said first-operation-result groups correspond to said document-category titles in a way of one-to-one;
for each of said first-operation-result groups, performing a second mathematical operation among the first-operation numbers therein, to obtain a plurality of category-to-object-document-relevance-evaluation numbers respectively corresponding to different ones of said document-category titles;
identifying one of said category-to-object-document-relevance-evaluation numbers which meets a reference condition;
assigning said object document one of said document-category titles which the identified one of said category-to-object-document-relevance-evaluation numbers corresponds to.

26. The apparatus according to claim 17 further comprising an operational portion for:
forming a first mathematical matrix with rows thereof respectively constituted by different ones of a plurality of reference-number groups, with each column thereof constituted by ones of said keyword-to-document-category-relevance-referring numbers which correspond to one of said key words, each of said reference-number groups includes ones of said keyword-to-document-category-relevance-referring numbers which correspond to one of said document-category titles, ones of said keyword-to-document-category-relevance-referring numbers which are in different columns of said first mathematical matrix respectively correspond to different ones of said key words, ones of said keyword-to-document-category-relevance-referring numbers which are in different rows of said first mathematical matrix respectively correspond to different ones of said document-category titles, thereby the columns of said first mathematical matrix correspond to said key words in a way of one-to-one, and the rows of said first mathematical matrix correspond to said document-category titles in a way of one-to-one, the columns of said first mathematical matrix reside from left to right in such a way that the ones of said key words corresponding thereto are in an arbitrarily selected order;
computing the frequency each of said key words appears in said object document, to obtain a plurality of frequency values respectively corresponding to different ones of said key words;
forming a second mathematical matrix composed of one column which is constituted by said frequency values respectively located from top to bottom in such a way that the ones of said key words corresponding thereto are in said arbitrarily selected order; and
multiplying said first mathematical matrix by said second mathematical matrix to obtain a third mathematical matrix composed of a plurality of category-to-object-document-relevance-evaluation numbers listed in one column, said category-to-object-document-relevance-evaluation numbers correspond to said document-category titles in a way of one-to-one;
identifying one of said category-to-object-document-relevance-evaluation numbers which meets a reference condition;
assigning said object document one of said document-category titles which the identified one of said category-to-object-document-relevance-evaluation numbers corresponds to.

27. The apparatus according to claim 25 wherein said database further comprising a category-judge-criteria-value and said operational portion is such that one of said category-to-object-document-relevance-evaluation numbers is identified if the magnitude thereof, in an order among said category-to-object-document-relevance-evaluation numbers, is larger than said category-judge-criteria-value.

28. An apparatus applied to an information management system in which at least one of a plurality of document-category titles is assigned to an object document that includes at least two key words, said apparatus comprising a data-storage portion having a database residing thereon, said database comprising:
a plurality of key-word-codes respectively representing different ones of said key words;
a plurality of category-codes respectively representing different ones of said document-category titles; and
a first mathematical matrix with rows thereof respectively constituted by different ones of a plurality of reference-number groups, wherein each of said reference-number groups includes a plurality of keyword-to-document-category-relevance-referring numbers all corresponding to one of said document-category titles, ones of said keyword-to-document-category-relevance-referring numbers which are in different rows of said first mathematical matrix correspond to different ones of said document-category titles, ones of said keyword-to-document-category-relevance-referring numbers which are in one column of said first mathematical matrix correspond to one of said key words, ones of said keyword-to-document-category-relevance-referring numbers which are in different columns of said first mathematical matrix correspond to different ones of said key words, thereby said key words correspond to the columns of said first mathematical matrix in a way of one-to-one, one of said keyword-to-document-category-relevance-referring numbers which corresponds to an arbitrarily selected one of said key words and to an arbitrarily selected one of said document-category titles relates to the probability the arbitrarily selected one of said key words appears in a document with the arbitrarily selected one of said document-category titles.

29. The apparatus according to claim 28 further comprising an operational portion, wherein the columns of said first mathematical matrix reside from left to right in such a way that the ones of said key-words corresponding thereto are in an arbitrarily selected order, and said operational portion is for:
computing a frequency each of said key words appears in said object document, to obtain a plurality of frequency values corresponding to said key words in a way of one-to-one;
forming a second mathematical matrix composed of one column constituted by said frequency values, wherein said frequency values reside on said column from top to bottom in such a way that the ones of said key words corresponding thereto are in said arbitrarily selected order;
multiplying said first mathematical matrix by said second mathematical matrix to obtain a third mathematical matrix composed of one column constituted by a plurality of category-to-object-document-relevance-evaluation numbers, said category-to-object-document-relevance-evaluation numbers corresponding to said document-category titles in a way of one-to-one;
assigning at least one of said document-category titles to said object document according to said category-to-object-document-relevance-evaluation numbers.

30. The apparatus according to claim 29 wherein one of said document-category titles is assigned to said object document if one of said category-to-object-document-relevance-evaluation numbers which corresponds to the one of said document-category titles has a magnitude meeting a reference condition.
